(19) United States
(12) Patent Application Publication
(10) Pub. No.: US 2025/0203375 A1
(43) Pub. Date: Jun. 19, 2025

(54) ELECTRONIC DEVICE AND CONTROL METHOD THEREFOR

(71) Applicant: Samsung Electronics Co., Ltd., Suwon-si (KR)

(72) Inventors: Seongil HAHM, Suwon-si (KR); Jinhwan KIM, Suwon-si (KR)

(21) Appl. No.: 19/071,003

(22) Filed: Mar. 5, 2025

Related U.S. Application Data
(63) Continuation of application No. PCT/KR2023/016605, filed on Oct. 25, 2023.

(30) Foreign Application Priority Data
Nov. 25, 2022 (KR) 10-2022-0160452

(51) Int. Cl. H04W 12/50; H04B 17/318; H04W 76/14

(52) U.S. Cl. CPC H04W 12/50; H04B 17/318; H04W 76/14

(57) ABSTRACT

An electronic device is provided. The electronic device includes a communication interface, memory storing one or more computer programs, and one or more processors communicatively coupled to the communication interface and the memory, wherein the one or more computer programs include computer-executable instructions that, when executed by the one or more processors individually or collectively, cause the electronic device to identify, based on a signal for a secure connection being received from an external device, a received signal strength indicator (RSSI) value of a received signal, transmit, based on a speaker being identified as comprised in the external device based on function information of the external device comprised in the received signal, feedback information to the external device through the communication interface based on the identified RSSI value, and perform, based on an updated signal being received from the external device based on the feedback information, the secure connection with the external device based on the updated signal.

### CROSS-REFERENCE TO RELATED APPLICATION(S)

This application is a continuation application, claiming priority under 35 U.S.C. § 365 (c), of an International application No. PCT/KR2023/016605, filed on Oct. 25, 2023, which is based on and claims the benefit of a Korean patent application number 10-2022-0160452, filed on Nov. 25, 2022, in the Korean Intellectual Property Office, the disclosure of which is incorporated by reference herein in its entirety.

### BACKGROUND

### 1. Field

The disclosure relates to an electronic device and a control method. More particularly, the disclosure relates to an electronic device that performs communication connection taking into consideration a strength of a signal received from an external device and a control method therefor.

### 2. Description of Related Art

With developments in electronic technology, electronic devices of various types are being developed and supplied. Specifically, recently, developments in technologies relating to Internet of Things (IoT), in which a plurality of devices is connected to a network and exchanges data, are becoming more active. A user may be provided with quality service through data exchange between a plurality of IoT devices present in a home.

Meanwhile, the IoT devices present in the home may be connected to a cloud server through relay devices such as a smart phone or connected to the internet. The above may be referred to as onboarding or commissioning, and in this case, an operation of relay devices performing ownership authentication for the IoT devices may be included.

To perform ownership authentication for the IoT devices, there is a method in which a mission is provided for a user to operate an IoT device in a specific method through a relay device, and when the user performs the mission corresponding thereto, ownership authentication for the IoT device is completed. However, because the above-described method requires user operation, there is the inconvenience of usability decreasing, and accordingly, a method of performing onboarding which includes an ownership authentication process through an in audible frequency audio signal has been proposed.

The relay device and the IoT device may generate a security communication channel by transmitting and receiving the inaudible frequency audio signal included with a personal identification number (PIN) code for ownership authentication of the IoT device, and the IoT device may be connected with the cloud server or connected to the internet using the information received through the generated security communication channel.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device that performs communication connection taking into consideration a strength of a signal received from an external device and a control method therefor.

Additional aspects will be set forth in part in the description which follows and, in part, will be apparent from the description, or may be learned by practice of the presented embodiments.

In accordance with an aspect of the disclosure, an electronic device is provided. The electronic device includes a communication interface, memory storing one or more computer programs, and one or more processors communicatively coupled to the communication interface and the memory, wherein the one or more computer programs include computer-executable instructions that, when executed by the one or more processors individually or collectively, cause the electronic device to identify, based on a signal for a secure connection being received from an external device, a received signal strength indicator (RSSI) value of the received signal, transmit, based on a speaker being identified as comprised in the external device based on function information of the external device comprised in the received signal, feedback information to the external device through the communication interface based on the identified RSSI value, and perform, based on an updated signal being received from the external device based on the feedback information, the secure connection with the external device based on the updated signal.

The one or more processors are configured to transmit, based on a speaker being identified as included in the external device based on function information of the external device included in the received signal, feedback information to the external device through the communication interface based on the identified RSSI value.

The one or more processors are configured to perform, based on an updated signal being received from the external device based on the feedback information, the secure connection with the external device based on the updated signal.

In accordance with another aspect of the disclosure, a control method performed by an electronic device is provided. The control method includes identifying, based on a signal for a secure connection being received from an external device, a received signal strength indicator (RSSI) value of the received signal, transmitting, based on a speaker being identified as comprised in the external device based on function information of the external device comprised in the received signal, feedback information to the external device based on the identified RSSI value, and performing, based on an updated signal being received from the external device based on the feedback information, the secure connection with the external device based on the updated signal.

The control method includes transmitting, based on a speaker being identified as included in the external device based on function information of the external device included in the received signal, feedback information to the external device based on the identified RSSI value.

The control method includes performing, based on an updated signal being received from the external device based on the feedback information, the secure connection with the external device based on the updated signal.

In accordance with another aspect of the disclosure, one or more non-transitory computer-readable recording media storing one or more computer programs including computer-executable instructions that, when executed by one or more processors of an electronic device individually or collectively, cause the electronic device to perform operations are provided. The operations include identifying, based on a signal for a secure connection being received from an external device, a received signal strength indicator (RSSI) value of the received signal, transmitting, based on a speaker being identified as comprised in the external device based on function information of the external device comprised in the received signal, feedback information to the external device based on the identified RSSI value, and performing, based on an updated signal being received from the external device based on the feedback information, the secure connection with the external device based on the updated signal.

The operations include transmitting, based on a speaker being identified as included in the external device based on function information of the external device included in the received signal, feedback information to the external device based on the identified RSSI value.

The operations include performing, based on an updated signal being received from the external device based on the feedback information, the secure connection with the external device based on the updated signal.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating schematically a control method of an electronic device according to an embodiment of the disclosure;

FIG. 2 is a block diagram illustrating a configuration of an electronic device according to an embodiment of the disclosure;

FIG. 3 is a flowchart illustrating a control method of an electronic device according to an embodiment of the disclosure;

FIG. 4 is a diagram illustrating a method for performing secure connection according to an embodiment of the disclosure;

FIG. 5 is a diagram illustrating a control method of an electronic device for when a speaker is included in an external device according to an embodiment of the disclosure;

FIG. 6 is a diagram illustrating a control method of an electronic device for when a microphone is included in an external device according to an embodiment of the disclosure;

FIG. 7 is a diagram illustrating a method for providing guide information according to an embodiment of the disclosure;

FIG. 8 is a sequence diagram illustrating an operation of a communication system for when a speaker is included in an external device according to an embodiment of the disclosure;

FIG. 9 is a sequence diagram illustrating an operation of a communication system for when a microphone is included in an external device according to an embodiment of the disclosure; and

FIG. 10 is a block diagram illustrating a detailed configuration of an electronic device according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

Terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms used in describing the embodiments of the disclosure are general terms selected that are currently widely used considering their function herein. However, the terms may change depending on intention, legal or technical interpretation, emergence of new technologies, and the like of those skilled in the related art. Further, in certain cases, there may be terms arbitrarily selected, and in this case, the meaning of the term will be disclosed in greater detail in the relevant description. Accordingly, the terms used herein are not to be understood simply as its designation but based on the meaning of the term and the overall context of the disclosure.

In the disclosure, expressions such as “have,” “may have”, “include”, and “may include” are used to designate a presence of a corresponding characteristic (e.g., elements such as numerical value, function, operation, or component), and not to preclude a presence or a possibility of additional characteristics.

The expression at least one of A and/or B is to be understood as indicating any one of “A” or “B” or “A and B”.

Expressions such as “1st”, “2nd”, “first” or “second” used in the disclosure may limit various elements regardless of order and/or importance, and may be used merely to distinguish one element from another element and not limit the relevant element.

When a certain element (e.g., a first element) is indicated as being “(operatively or communicatively) coupled with/to” or “connected to” another element (e.g., a second element), it may be understood as the certain element being directly coupled with/to the another element or as being coupled through other element (e.g., a third element).

It is to be understood that the terms such as “form” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

The term “module” or “part” used in one or more embodiments herein perform at least one function or operation, and may be implemented with a hardware or software, or implemented with a combination of hardware and software. In addition, a plurality of “modules” or a plurality of “parts”, except for a “module” or a “part” which needs to be implemented with a specific hardware, may be integrated in at least one module and implemented as at least one processor (not shown).

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

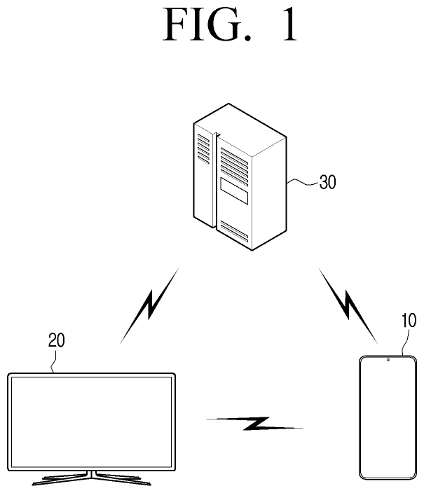

FIG. 1 is a diagram illustrating schematically a control method of an electronic device according to an embodiment of the disclosure.

Referring to FIG. 1, an electronic device 10 according to an embodiment may receive a signal for communication connection from an external device 20. The electronic device 10 according to an embodiment may be implemented with a smartphone, but is not limited thereto, and may be implemented with a smart TV according to an example. The external device 20 may be Internet of Things (IoT) devices of different types such as, for example, and without limitation, an air conditioner, a speaker, a projector, an air purifier, a fan, a refrigerator, a robot, and the like.

The electronic device 10 according to an embodiment may perform a secure connection with the external device 20 based on a signal received from the external device 20, and the external device 20 may be communicatively connected with a server 30 based on data received from the electronic device 10 which is securely connected. Here, a secure connection may mean a communication connection in which data is transmitted and received in an encrypted state. According to an example, the external device 20 may be communicatively connected, when information for communicatively connecting with the server 30 is received from the electronic device 10 which is securely connected, with the server 30 based on the received information.

According to an embodiment, the secure connection may be implemented with datagram transport layer security (DTLS) technology. DTLS may be an encryption protocol implemented with secure sockets layer (SSL) technology in a user datagram protocol (UDP), and the UDP may be a protocol used in a transport layer which is the fourth layer in an open systems interconnection (OSI) reference model developed with an international communication standard. Meanwhile, the SSL may mean a standard technology for protecting internet connection by encrypting data transmitted between a server corresponding to a website and a server corresponding to a browser. According to an example, the electronic device 10 may be securely connected with the external device 20 in a DTLS method based on the signal received from the external device 20. However, the embodiment is not limited thereto.

To perform the secure connection, the electronic device 10 or the external device 20 according to an embodiment may output an audio signal included with information for the secure connection. Based on the electronic device 10 according to an example outputting the audio signal, the external device 20 may perform the secure connection with the electronic device 10 by receiving the audio signal output from the electronic device 10. Alternatively, based on the external device 20 outputting the audio signal according to an example, the electronic device 10 may perform the secure connection with the external device 20 by receiving the audio signal output from the external device 20.

Meanwhile, if a distance between the electronic device 10 and the external device 20 is far or if a strength of the audio signal output from the electronic device 10 or the external device 20 is low, the communication connection between the electronic device 10 or the external device 20 may not be performed properly due to a strength of an audio received by the electronic device 10 or the external device 20 being small. Alternatively, if the strength of the audio signal output from the electronic device 10 or the external device 20 is high, another electronic device other than the electronic device 10 may receive a communication connection signal, and based therefrom, the external device 20 may be securely connected with another electronic device rather than the electronic device 10.

Accordingly, by outputting an audio signal taking into consideration the strength of the signal that transmitted or received feedback information for the audio signal being output taking into consideration the strength of the signal received from the external device 20, various embodiments in which a success rate for the communication connection with the external device 20 may be raised will be described below

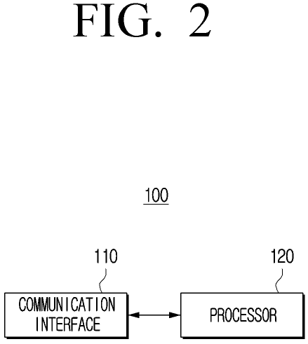

FIG. 2 is a block diagram illustrating a configuration of an electronic device according to an embodiment of the disclosure.

Referring to FIG. 2, an electronic device 100 may include a communication interface 110 and one or more processors 120.

The electronic device 100 according to an embodiment may include at least one from among a smartphone, a tablet personal computer (PC), a laptop PC, a netbook computer, a mobile medical device, a wearable device, and a smart TV, but is not limited thereto, and may be implemented as various devices which can perform communication with an external device.

Meanwhile, an external server may transmit information to the electronic device 100 through various methods. The electronic device 100 may communicatively connect with the external device and the external server through various methods. According to an embodiment, a communication module for communication with the external device and the external server may be identically implemented. For example, the electronic device 100 may communicate with the external device using a Bluetooth module, and communicate with the external server also using the Bluetooth module.

According to another embodiment, the communication modules for communication with the external device and the external server may be implemented separately. For example, the electronic device 100 may communicate with the external device using the Bluetooth module, and communication with the external server using an Ethernet modem or a Wi-Fi module.

The communication interface 110 may input and output data of various types. For example, the communication interface 110 may transmit and receive data of various types with an external device (e.g., source device), an external storage medium (e.g., USB memory), or an external server (e.g., WEBHARD) through communication methods such as, for example, and without limitation, an AP based Wi-Fi (e.g., Wi-Fi, wireless LAN network), Bluetooth, ZigBee, a wired/wireless local area network (LAN), a wide area network (WAN), Ethernet, IEEE 1394, a high-definition multimedia interface (HDMI), a universal serial bus (USB), a mobile high-definition link (MHL), Audio Engineering Society/European Broadcasting Union (AES/EBU), Optical, Coaxial, or the like.

The communication interface 110 according to an example may use the same communication module (e.g., Wi-Fi module) to communicate with the external device and the external server.

The communication interface 110 according to an example may use different communication modules to communicate with the external device and the external server. For example, the communication interface 110 may use at least one from among an Ethernet module or the Wi-Fi module to communicate with the external server, and use the Bluetooth module to communicate with the external device. However, the above is merely one embodiment, and the communication interface 110 may use at least one communication module from among various communication modules when communicating with a plurality of external devices or external servers.

The one or more processors 120 (hereinafter, referred to as a ‘processor’) may control the overall operation of the electronic device 100 by being electrically connected with the communication interface 110. The processor may be configured with one or a plurality of processors. Specifically, the processor 120 may perform, by executing at least one instruction stored in memory (not shown), an operation of the electronic device 100 according to various embodiments of the disclosure.

The processor 120 according to an embodiment may be implemented as a digital signal processor (DSP) for processing a digital image signal, a microprocessor, a graphics processing unit (GPU), an artificial intelligence (AI) processor, a neural processing unit (NPU), or a time controller (TCON). However, the embodiment is not limited thereto, and may include one or more from among a central processing unit (CPU), a micro controller unit (MCU), a micro processing unit (MPU), a controller, an application processor (AP), a communication processor (CP), or an ARM processor, or may be defined by the corresponding term. In addition, the processor 120 may be implemented as a System on Chip (SoC) or a large scale integration (LSI) in which a processing algorithm is embedded, and may be implemented in a form of an application specific integrated circuit (ASIC) or a field programmable gate array (FPGA).

The processor 120 according to an embodiment may be implemented as the digital signal processor (DSP), the microprocessor, or the time controller (TCON). However, the embodiment is not limited thereto, and may include one or more from among the central processing unit (CPU), the micro controller unit (MCU), the micro processing unit (MPU), the controller, the application processor (AP), the communication processor (CP), or the ARM processor, or may be defined by the corresponding term. In addition, the processor 120 may be implemented as the System on Chip (SoC) or the large scale integration (LSI) in which the processing algorithm is embedded, and may be implemented in the form of the field programmable gate array (FPGA).

According to an embodiment, the processor 120 may receive a signal for a secure connection from the external device. The external device 20 may be Internet of Things (IoT) device of various types such as, for example, and without limitation, an air conditioner, a speaker, a projector, an air purifier, a fan, a refrigerator, a robot, and the like according to an example. Meanwhile, the signal for the secure connection may include at least one from among information on a personal identification number (PIN) code for ownership authentication of the external device or function information of the external device according to an example, but is not limited thereto, and information on a personal identification number (PIN) code for ownership authentication of the electronic device 100 may be included. Meanwhile, the secure connection according to an example, may be a secure connection of a DTLS type.

According to an example, the processor 120 may receive an audio signal included with information on the personal identification number (PIN) code for ownership authentication of the external device, and the audio signal may be a signal of an inaudible frequency band. For example, the processor 120 may receive an audio signal for a secure connection through a microphone (not shown).

In addition, the processor 120 according to an example may receive a wireless communication signal included with function information of the external device through the communication interface 110. Here, the function information of the external device may be information on at least one from among at least one configuration included in the external device or a capability of the external device. For example, if a speaker and a microphone are included in the external device, information notifying that the speaker and the microphone are included in the function information of the external device may be included. However, the above is not limited thereto, and for example, information notifying that a sound source receiving function or a sound source transmitting function is included in the external device may be included.

Meanwhile, the wireless communication signal according to an example may be a signal of at least one type from among a Wireless-Fidelity (Wi-Fi) signal or a Bluetooth low energy (BLE) advertising signal. For example, the external device may broadcast a BLE advertising signal included with function information of the external device, and the processor 120 may receive the BLE advertising signal broadcasted from the external device through the communication interface 110.

Alternatively, for example, the external device may broadcast a soft access point (AP) advertising signal included with function information of the external device. The processor 120 may receive the soft AP advertising signal broadcasted from the external device through the communication interface 110, but is not limited thereto, and wireless communication signals or wired communication signals of different types may be received.

According to an embodiment, the processor 120 may identify, based on the signal for the secure connection being received, a received signal strength indicator (RSSI) value of the received signal. Here, the RSSI value may mean a strength of the received signal for the secure connection. According to an example, the processor 120 may identify, based on the audio signal included with information on the PIN code for ownership authentication of the external device being received, the RSSI value of the received audio signal. Alternatively, the processor 120 according to an example may identify, based on the wireless communication signal included with function information of the external device being received, the RSSI value of the received wireless communication signal.

According to an embodiment, the processor 120 may identify whether at least one from among the speaker or the microphone is included in the external device based on function information of the external device included in the received signal.

According to an embodiment, the processor 120 may transmit feedback information to the external device based on the identified RSSI value.

According to an example, the processor 120 may transmit, based on the speaker being identified as included in the external device based on function information of the external device included in the received signal, feedback information associated a strength of the RSSI value to the external device through the communication interface 110 based on the identified RSSI value. Here, the feedback information may mean information for changing a strength of a signal being transmitted from the external device for the strength of the signal received from the external device to be included in a pre-set range if the strength of the received signal is outside the pre-set range. Meanwhile, information on the pre-set range may be pre-stored in memory (not shown), or included in the wireless communication signal received from the external device.

For example, the processor 120 may transmit, based on the strength of the received audio signal being lower than a minimum value from among values corresponding to the pre-set range, feedback information for increasing the strength of the audio signal transmitted from the external device through the communication interface 110 to the external device. Alternatively, the processor 120 may transmit, based on the strength of the received audio signal being higher than the pre-set range, feedback information for reducing the strength of the audio signal transmitted from the external device through the communication interface 110 to the external device. Meanwhile, information on the pre-set range may be stored in memory (not shown) at an initial setting, but is not limited thereto, and may be obtained based on a user input according to an example.

If the strength of the received audio signal is smaller than a pre-set value, the processor 120 may not identify the audio signal. Because the above is a reason for lowering a success rate of the secure connection, the success rate of communication connection may increase so long as an audio signal having an RSSI size of greater than or equal to a pre-set value is received. In addition, if the strength of the received audio signal is greater than the pre-set value, communication connection with another electronic device other than the electronic device 100 present in a home may be carried out. Accordingly, the strength of the signal transmitted by the external device has to be included in the pre-set range in order to increase the success rate for the communication connection with the electronic device 100 present in the home.

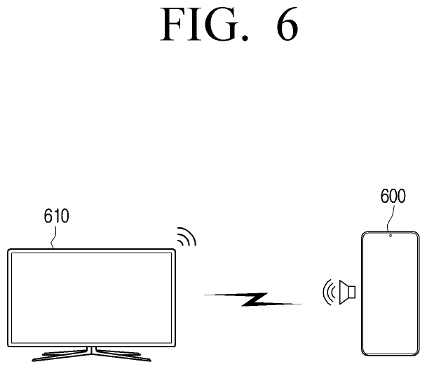

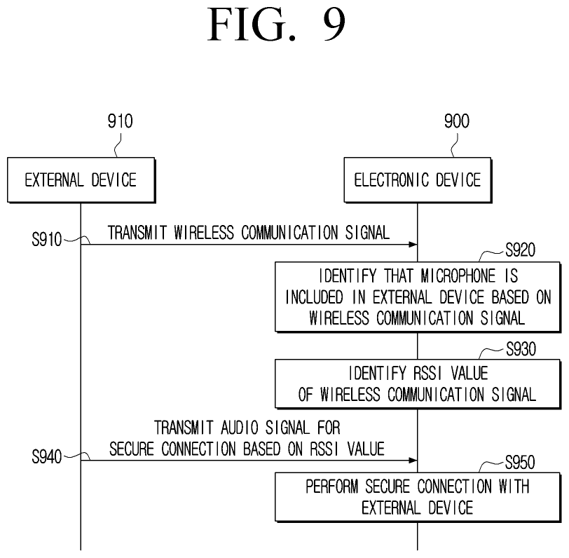

Meanwhile, the processor 120 according to an embodiment may output an audio signal for the secure connection with the external device through a speaker (not shown). The above will be described in detail through FIG. 6 and FIG. 9.

Meanwhile, the processor 120 according to an embodiment may receive an updated signal from the external device based on the feedback information. According to an example, if the feedback information which increases the strength of the audio signal being transmitted from the external device is transmitted to the external device, the processor 120 may receive an audio signal with the RSSI value being greater than or equal to the pre-set value from the external device through the communication interface 110.

According to an embodiment, the processor 120 may perform the secure connection with the external device based on the updated signal. According to an example, the processor 120 may perform, based on an audio signal of a strength changed based on the feedback information being received from the external device through the microphone (not shown), the secure connection with the external device based on the audio signal of the changed strength.

For example, the processor 120 may perform, based on an audio signal included with information on the PIN code for ownership authentication of the external device being received as a signal with the RSSI value being greater than or equal to the pre-set value, the secure connection with the external device based on the received audio signal.

Then, if the secure connection is carried out with the external device according to an embodiment, the processor 120 may transmit communication connection information to be communicatively connected with the external device and the external server (not shown) to the external device through the communication interface 110. The communication connection information may include at least one from among, for example, access point (AP) information or user account information, but is not limited thereto. The AP information may mean information on an AP device that performs a function of connecting an IOT device with a server, and SSID information corresponding to the AP and password information may be included in the AP information according to an example. Meanwhile, the user account information may mean ID and password information of a user account necessary for performing network connection through the server. The external device may be communicatively connected with the external server using the received communication connection information.

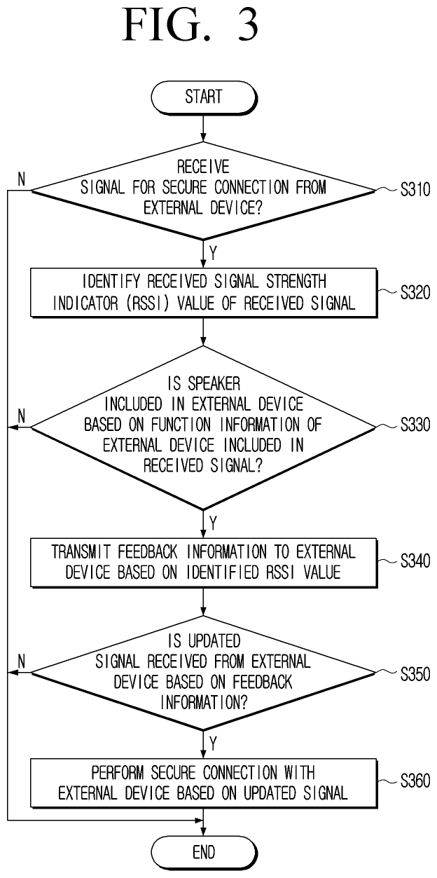

FIG. 3 is a flowchart illustrating a control method of an electronic device according to an embodiment of the disclosure.

Referring to FIG. 3, a control method according to an embodiment may identify whether a signal for secure connection is received from the external device at operation S310. According to an example, the processor 120 may receive an audio signal included with information on the personal identification number (PIN) code for ownership authentication of the external device though the microphone (not shown). In this case, the audio signal according to an example may be a signal of an inaudible frequency band. In addition, the processor 120 according to an example may receive the wireless communication signal included with function information of the external device through the communication interface 110.

Then, the control method according to an embodiment may identify, based on the signal for secure connection being received from the external device (Y), the received signal strength indicator (RSSI) value of the received signal at operation S320. According to an example, the processor 120 may identify the RSSI value of the audio signal included with information on the PIN code for ownership authentication of the external device.

Then, the control method according to an embodiment may identify whether the speaker is included in the external device based on function information of the external device included in the received signal at operation S330. According to an example, the processor 120 may identify as the speaker being included in the external device based on function information of the external device included in the received wireless communication signal.

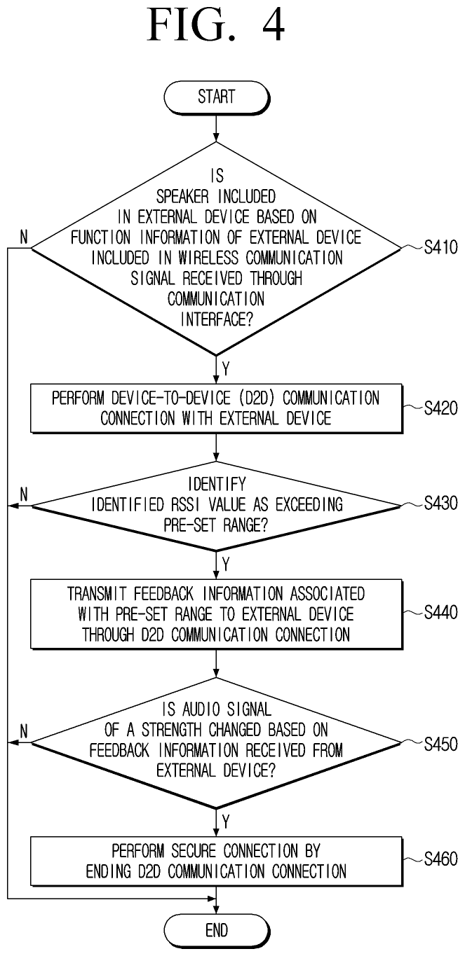

Then, if the speaker is identified as included in the external device according to an embodiment (Y), the control method may include transmitting the feedback information to the external device based on the identified RSSI value at operation S340. According to an example, the processor 120 may obtain, based on the identified RSSI value of the audio signal being identified as less than the minimum value from among the values corresponding to the pre-set range, feedback information for increasing the strength of the audio signal being transmitted from the external device. Then, if the speaker is identified as included in the external device, the processor 120 may transmit the obtained feedback information to the external device through the communication interface 110. In this case, the external device and the electronic device 100 may be in a state connected via device-to-device (D2D) communication, and the above will be described in detail through FIG. 4.

Then, the control method according to an embodiment may identify whether an updated signal is received from the external device based on the feedback information at operation S350. According to an example, the processor 120 may identify whether an audio signal with the RSSI value being greater than or equal to the pre-set value is received from the external device that received the feedback information for increasing the strength of the audio signal which is being transmitted from the external device.

Then, the control method according to an embodiment may perform, based on an updated signal being received from the external device (Y), the secure connection with the external device based on the updated signal at operation S360. According to an example, the processor 120 may perform, based on the audio signal included with information for the secure connection with the external device being received as the signal having the RSSI value within the pre-set range, the secure connection with the external device based therefrom.

According to the above-described example, the electronic device 100 may be able to transmit feedback information for the external device by identifying whether the strength of the signal received from the external device is included within the pre-set range, and the external device may transmit an updated audio signal for successfully performing the secure connection based on the feedback information. Accordingly, the success rate of the communication connection between the electronic device 100 and the external device may be raised, and user satisfaction may be improved.

FIG. 4 is a diagram illustrating a method for performing secure connection according to an embodiment of the disclosure.

Referring to FIG. 4, according to an embodiment, the control method may include identifying whether the speaker is included in the external device based on function information of the external device included in the wireless communication signal received through the communication interface 110 at operation S410. According to an example, the processor 120 may receive the BLE advertising signal included with function information of the external device from the external device through the communication interface 110, and the processor 120 may identify that the speaker is included in the external device based therefrom.

Then, the control method according to an embodiment may include performing, based on the speaker being identified as included in the external device (Y), connection via device-to-device (D2D) communication with the external device at operation S420. Here, the connection via D2D communication may mean technology with which communication connection is carried out between devices without having to pass through a separate communication connection device (or, infrastructure) such as a base station or a router (access point). According to an example, the processor 120 may be connected via D2D communication with the external device that transmitted the BLE advertising signal included with function information of the external device through the communication interface 110.

Then, the control method according to an embodiment may identify whether the identified RSSI value exceeded the pre-set range at operation S430. According to an example, the memory may be included with information associated with the pre-set range with respect to the RSSI values, and the processor 120 may identify the RSSI value of the audio signal included with information on the PIN code for ownership authentication of the external device, and identify whether the identified RSSI value exceeded the pre-set range based on information stored in the memory (not shown).

Alternatively, the wireless communication signal according to an example may include at least one from among information on a minimum value or a maximum value of the RSSI value for the secure connection, and the processor 120 may identify whether the identified RSSI value exceeds the pre-set range based on information on the minimum value or the maximum value of the RSSI value included in the received wireless communication signal.

Then, the control method according to an embodiment may include transmitting, based on the identified RSSI value exceeding the pre-set range (Y), feedback information associated with the pre-set range to the external device through a D2D communication channel at operation S440. The processor 120 according to an example may transmit, based on the identified RSSI value of the audio signal being identified as not included in the pre-set range according to the RSSI value being less than the minimum value from among the values corresponding to the pre-set range, feedback information for increasing the strength of the audio signal being transmitted from the external device to the external device through the D2D communication channel. Alternatively, the processor 120 according to an example may transmit, based on the identified RSSI value of the audio signal being identified as not included in the pre-set range according to the RSSI value exceeding the maximum value from among the values corresponding to the pre-set range, feedback information for reducing the strength of the audio signal being transmitted from the external device to the external device through the D2D communication channel.

Then, the control method according to an embodiment may include identifying whether the audio signal of the strength changed based on the feedback information is received from the external device at operation S450. According to an example, the processor 120 may receive the audio signal having the RSSI value within the pre-set range from the external device through the microphone (not shown) based on the feedback information for increasing the strength of the audio signal transmitted from the external device being transmitted to the external device.

Then, the control method according to an embodiment may include ending, based on the audio signal of the changed strength being received from the external device (Y), the connection via D2D communication and performing the secure connection at operation S460. According to an example, the processor 120 may end, based on the audio signal having the RSSI value within the pre-set range being received according to the feedback information for increasing the strength of the audio signal being transmitted from the external device being transmitted to the external device, the connection via D2D communication with the external device and perform the secure connection. Here, the connection via D2D communication may be a communication connection of a different type from the secure connection, and the connection via D2D communication according to an example may be a type of communication connection in which a signal that is being transmitted and received is not encrypted unlike a secure communication connection.

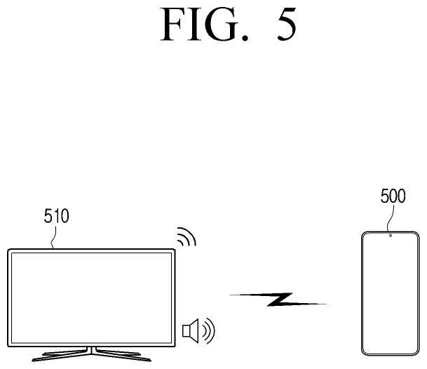

FIG. 5 is a diagram illustrating a control method of an electronic device for when a speaker is included in an external device according to an embodiment of the disclosure.

Referring to FIG. 5, an external device 510 according to an embodiment may include a speaker. The external device 510 shown in FIG. 5 may be a television (TV), but is not limited thereto, and the external device 510 according to an embodiment may be an IoT device of a different type that includes a speaker.

According to an embodiment, the processor 120 of an electronic device 500 may receive the audio signal for the secure connection from the external device 510 through the microphone (not shown), and receive the wireless communication signal including function information of the external device from the external device 510 through the communication interface 110.

The processor 120 according to an embodiment may transmit, based on the RSSI value of the received signal being identified as steadily reducing over time, feedback information for steadily increasing the RSSI value based on the pre-set range to the external device 510 through the communication interface 110.

According to an example, it may be assumed that a distance between the electronic device 500 and the external device 510 is steadily increased over time. The processor 120 may identify as the RSSI value of the audio signal received from the external device 510 being steadily decreased over time. For example, the processor 120 may identify the RSSI value of the signal received from the external device 510 at every pre-set period, and transmit, based on the RSSI value identified at every pre-set period being identified as steadily decreasing, feedback information for steadily increasing the RSSI value to be included in the pre-set range to the external device 510 through the communication interface 110.

Meanwhile, even if the RSSI value of the received signal is within the pre-set range according to an example, the processor 120 may transmit feedback information for controlling an output strength of the audio signal.

For example, the processor 120 may identify the RSSI value of the audio signal received from the external device 510 at every pre-set period. Based on the RSSI value of the received audio signal being identified as steadily decreasing within the pre-set range over time, feedback information for steadily increasing the RSSI value of the audio signal within the pre-set range may be transmitted to the external device 510 through the communication interface 110. That is, the processor 120 may transmit, based on the RSSI value of the received audio signal being identified as steadily decreasing over time even when the RSSI value of the received audio signal is within the pre-set range, feedback information for steadily increasing the output strength of the audio signal within the pre-set range to the external device 510 in order to raise the success rate of the communication connection between the electronic device 500 and the external device 510.

Alternatively, for example, the processor 120 may transmit, based on the RSSI value of the received audio signal being identified as steadily increasing within the pre-set range over time, feedback information for steadily reducing the RSSI value of the audio signal within the pre-set range to the external device 510 through the communication interface 110. That is, the processor 120 may transmit, based on the RSSI value of the received audio signal being identified as steadily increasing over time even when the RSSI value of the received audio signal is within the pre-set range, feedback information for steadily reducing the output strength of the audio signal within the pre-set range to the external device 510 to raise the success rate of the communication connection between the electronic device 500 and the external device 510. Meanwhile, the processor 120 according to an embodiment may identify an RSSI value for a secure connection based on information included in a signal received from the external device 510. According to an example, the wireless communication signal may include at least one from among information on the minimum value or the maximum value of the RSSI value for the secure connection. The processor 120 may identify feedback information based on at least one from among information on the minimum value or the maximum value of the RSSI value included in the received wireless communication signal.

According to an example, the processor 120 may transmit, based on the RSSI value identified based on at least one from among the minimum value or the maximum value being identified as exceeding the pre-set range, feedback information associated with the pre-set range to the external device 510 through connection via D2D communication. For example, the processor 120 may obtain, based on the identified RSSI value of the audio signal being less than the minimum value of the RSSI value included in the wireless communication signal, feedback information for increasing the strength of the audio signal being transmitted from the external device 510, and transmit the above to the external device 510 through the connection via D2D communication. Alternatively, for example, the processor 120 may obtain, based on the RSSI value of the audio signal being greater than the maximum value of the RSSI value included in the wireless communication signal based on information included in the received wireless communication signal, feedback information for reducing the strength of the audio signal being transmitted from the external device 510, and transmit the above to the external device 510 through the connection via D2D communication.

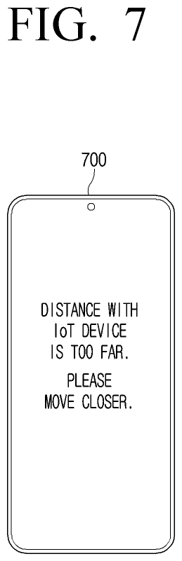

Meanwhile, the processor 120 according to an embodiment may provide guide information. According to an example, the processor 120 may provide, based on the identified RSSI value being identified as exceeding the pre-set range, guide information that guides the electronic device 500 to be positioned within a pre-set distance from the external device 510. The above will be described in detail through FIG. 7.

FIG. 6 is a diagram illustrating a control method of an electronic device for when a microphone is included in an external device according to an embodiment of the disclosure.

Referring to FIG. 6, an electronic device 600 according to an embodiment may further include a speaker (not shown), and the processor 120 may output an audio signal for a secure connection through the speaker (not shown). In an audio signal output by the electronic device 600, at least one from among information on a personal identification number (PIN) code for ownership authentication of an external device 610 or information on the PIN code for ownership authentication of the electronic device 600 may be included according to an example, and the audio signal may be a signal of an inaudible frequency band. Meanwhile, the external device 610 shown in FIG. 6 according to an example may be IoT devices of different types which include a microphone.

According to an embodiment, the processor 120 may identify, based on a wireless communication signal with function information of the external device 610 being first received from the external device 610 through the communication interface 110, an RSSI value of the received wireless communication signal.

According to an embodiment, the processor 120 may output, based on the microphone being identified as included in the external device 610 based on function information of the external device 610 included in the wireless communication signal, an audio signal for a secure connection with the external device 610 through the speaker (not shown) of the electronic device 600 based on the RSSI value of the identified wireless communication signal.

According to an example, the electronic device 600 may further include memory (not shown) stored with output size information (or, output strength information) of audio signals corresponding respectively to a plurality of RSSI values. The processor 120 may identify, based on an RSSI value of the wireless communication signal received from the external device 610 being identified as less than the pre-set value, an output size of the audio signal based on output size information of the audio signals corresponding respectively to the plurality of RSSI values stored in the memory (not shown), and control the speaker (not shown) to output an audio signal greater than or equal to the identified output size (or, output strength).

For example, it may be assumed that the RSSI value of the pre-set range is between 30 and 60. If the RSSI value of the wireless communication signal received from the external device is 20, the processor 120 may identify that an RSSI value of a signal received based on information on the pre-set range stored in the memory (not shown) exceeded the pre-set range based on the RSSI value being less than 30 which is the minimum value from among the values within the pre-set range. The processor 120 may identify an output size of an audio signal corresponding to 30 which is the minimum value from among the RSSI values included in the pre-set range based on the output size information of the audio signals corresponding respectively to the stored plurality of RSSI values, and control the speaker (not shown) to output an audio signal by greater than or equal to the identified output size of the audio signal.

Alternatively, for example, the processor 120 may identify whether the identified RSSI value of the wireless communication signal is less than the pre-set value based on information on at least one from among the minimum value (e.g., 30) or the maximum value (e.g., 60) of the RSSI value included in the received wireless communication signal. The processor 120 may identify that the RSSI value of the signal received based on information on at least one from among the minimum value or the maximum value of the RSSI value has exceeded the pre-set range according to the RSSI value being less than 30 which is the minimum value from among the values within the pre-set range. The processor 120 may identify an output size of the audio signal corresponding to 30 which is the minimum value based on the output size information of the audio signals corresponding respectively to the stored plurality of RSSI values, and control the speaker (not shown) to output the audio by greater than or equal to the identified output size of the audio signal.

However, the embodiment is not limited thereto, and the processor 120 for example may identify whether the identified RSSI value of the wireless communication signal exceeded the pre-set value based on at least one from among information on at least one from among the minimum value or the maximum value of the RSSI value included in the received wireless communication signal or information on the pre-set range associated with the RSSI values stored in the memory (not shown).

Meanwhile, according to an embodiment, the processor 120 may control, based on the RSSI value of the received wireless communication signal being identified as steadily decreasing over time, the speaker (not shown) of the electronic device 600 for the output strength of the audio signal to steadily increase based on information stored in the memory (not shown).

According to an example, it may be assumed that a distance between the electronic device 600 and the external device 610 steadily increases over time. The processor 120 may identify that the RSSI value of the audio signal received from the external device 610 steadily decreases over time. For example, the processor 120 may identify the RSSI value of the signal received from the external device 610 for each pre-set period. If the RSSI value identified for each pre-set period is identified as steadily decreasing, the speaker (not shown) of the electronic device 600 may be controlled for the output strength of the audio signal to be steadily increased. Alternatively, the processor 120 may output, through the speaker (not shown), the audio signals corresponding to the RSSI values included in the pre-set range based on the information stored in the memory (not shown).

Meanwhile, according to an embodiment, even if the RSSI value of the received signal is within the pre-set range, the processor 120 may control the output strength of the audio signal.

According to an example, it may be assumed that the RSSI value of the wireless communication signal being received is within the pre-set range. The processor 120 may control, based on the RSSI value of the received wireless communication signal being identified as steadily decreasing within the pre-set range over time, the speaker (not shown) of the electronic device 600 for the output strength of the audio signal to be steadily increased within the pre-set range based on the information stored in the memory (not shown). That is, the processor 120 may control, based on the RSSI value of the received wireless communication signal being identified as steadily decreasing over time even if the RSSI value of the received signal is within the pre-set range, the speaker (not shown) of the electronic device 600 for the output strength of the audio signal to be steadily increased in order to raise the success rate of the communication connection between the electronic device 600 and the external device 610.

Alternatively, the processor 120 according to an example may control, based on the RSSI value of the received wireless communication signal being identified as steadily increasing within the pre-set range over time, the speaker (not shown) of the electronic device 600 for the output strength of the audio signal to be steadily increased within the pre-set range based on the information stored in the memory (not shown). That is, the processor 120 may control, based on the RSSI value of the received wireless communication signal being identified as steadily increasing over time even if the RSSI value of the received signal is within the pre-set range, the speaker (not shown) of the electronic device 600 for the output strength of the audio signal to be steadily decreased in order to raise the success rate of the communication connection between the electronic device 600 and the external device 610.

Meanwhile, the processor 120 according to an embodiment may provide guide information. According to an example, the processor 120 may provide, based on the identified RSSI value being identified as exceeding the pre-set range, guide information that guides the electronic device 600 to be positioned within a pre-set distance from the external device 610. The above will be described in detail through FIG. 7.

FIG. 7 is a diagram illustrating a method for providing guide information according to an embodiment of the disclosure.

Referring to FIG. 7, the processor 120 according to an embodiment may provide, based on the identified RSSI value being identified as exceeding the pre-set range, guide information that guides an electronic device 700 to be positioned within a pre-set distance from an external device.

According to an example, the processor 120 may provide, based on an RSSI value of an audio signal received from the external device through a microphone (not shown) being less than a pre-set value, guide information that guides the electronic device 700 to be positioned within a pre-set distance from the external device. For example, the processor 120 may provide a UI included with information corresponding to ‘Distance with the IoT device is too far. Please move closer.’ through a display (not shown). However, the embodiment is not limited thereto, and a UI included with a text different from the above-described text may be provided.

Alternatively, according to an example, the processor 120 may provide, based on the RSSI value of the wireless communication signal received from the external device through the communication interface 110 being less than the pre-set value, guide information that guides the electronic device 700 to be positioned within the pre-set distance from the external device. For example, the processor 120 may provide the UI included with information corresponding to ‘Distance with the IoT device is too far. Please move closer.’ through the display (not shown). However, the embodiment is not limited thereto, and a UI included with a text different from the above-described text may be provided.

Referring back to FIG. 2, the processor 120 according to an embodiment may perform, based on the speaker and the microphone being identified as included in the external device, the secure connection with the external device based on the priority order of the speaker and the microphone.

According to an example, the processor 120 may identify, based on the speaker and the microphone being identified as included in the external device based on function information of the external device included in the wireless communication signal received from the external device, the priority order of the speaker and the microphone. For example, the processor 120 may identify the priority order of the microphone and the speaker based on information on the priority order of the speaker and the microphone stored in the memory (not shown). Alternatively, the processor 120 for example may identify the priority order of the speaker and the microphone based on information on the priority order of the speaker and the microphone included in the wireless communication signal received from the external device.

According to an example, if the priority order of the speaker is identified as high, the processor 120 may transmit feedback information to the external device through the communication interface 110 based on the identified RSSI value. For example, the processor 120 may identify, based on the priority order of the speaker being identified as high based on the information stored in the memory (not shown), feedback information based on the RSSI value of the audio signal received from the external device, and transmit the identified feedback information to the external device through the communication interface 110.

Alternatively, according to an example, if the priority order of the microphone is identified as high, the processor 120 may output the audio signal for the secure connection with the external device through the speaker (not shown) of the electronic device 100 based on the identified RSSI value of the wireless communication signal. For example, if the RSSI value of the wireless communication signal received from the external device is less than the pre-set value, the processor 120 may control the speaker (not shown) of the electronic device 100 to output the audio signal by greater than or equal to a pre-set output strength based on the information stored in the memory (not shown).

According to the above-described example, if the speaker and the microphone are included in the external device, the electronic device 100 may transmit feedback information to the external device based on a pre-set priority order or output the audio signal through the speaker (not shown).

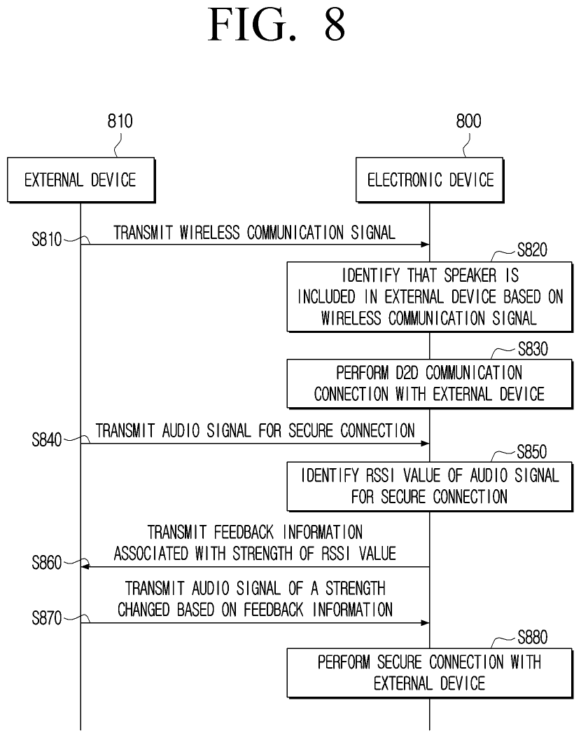

FIG. 8 is a sequence diagram illustrating an operation of a communication system for when a speaker is included in an external device according to an embodiment of the disclosure.

Referring to FIG. 8, according to an embodiment, an external device 810 may first transmit a wireless communication signal to an electronic device 800 at operation S810. According to an example, the external device 810 may broadcast a Wireless-Fidelity (Wi-Fi) signal or Bluetooth low energy (BLE) advertising signal included with function information of the external device 810.

Then, the electronic device 800 according to an embodiment may identify that a speaker is included in the external device 810 based on the received wireless communication signal at operation S820. According to an example, the electronic device 800 may identify that the speaker is included in the external device 810 based on function information of the external device 810 included in the received wireless communication signal.

Then, the electronic device 800 according to an embodiment may perform a device-to-device (D2D) communication connection with the external device 810 at operation S830. According to an example, the electronic device 800 may perform the device-to-device (D2D) communication connection with the external device 810 if the speaker is identified as included in the external device 810.

Then, the external device 810 according to an embodiment may transmit an audio signal for a secure connection to the electronic device 800 at operation S840. According to an example, the external device 810 may control the speaker of the external device 810 to output the audio signal for the secure connection. Here, in the audio signal for the secure connection, information on a personal identification number (PIN) code for ownership authentication of the external device 810 may be included, and the audio signal according to an example may be a signal of an inaudible frequency band.

Then, the electronic device 800 according to an embodiment may identify an RSSI value of the audio signal for the secure connection at operation S850. According to an example, the electronic device 800 may receive the audio signal for the secure connection from the external device 810 through the microphone. When the audio signal is received, the electronic device 800 may identify the RSSI value of the received audio signal.

Then, the electronic device 800 according to an embodiment may transmit feedback information associated with a strength of the identified RSSI value to the external device 810 at operation S860. According to an example, the electronic device 800 may transmit, based on the strength of the received audio signal being smaller than the minimum value from among the values corresponding to the pre-set range, feedback information for increasing the strength of the audio signal being transmitted from the external device 810 through the communication interface 110 to the external device 810. Alternatively, the electronic device 800 may transmit, based on the strength of the received audio signal being greater than the pre-set range, feedback information for decreasing the strength of the audio signal being transmitted from the external device 810 to the external device 810 through the communication interface 110.

Meanwhile, the electronic device 800 according to an example may obtain feedback information based on information stored in memory (not shown), but is not limited thereto, and may obtain feedback information based on information on at least one from among the minimum value or the maximum value of the RSSI value for the secure connection included in the wireless communication signal received from the external device 810. Meanwhile, the information on the pre-set range may be stored in the memory (not shown) at initial setting, but is not limited thereto, and may be obtained based on a user input according to an example.

Then, the external device 810 according to an embodiment may transmit the audio signal of a strength changed based on feedback information at operation S870. According to an example, if feedback information which increases the strength of the audio signal being transmitted from the external device 810 is received from the electronic device 800, the external device 810 may output an audio signal having a strength greater than or equal to the pre-set value through the speaker based therefrom.

Meanwhile, the electronic device 800 according to an example may identify feedback information which outputs the audio signal at a strength greater than or equal to the pre-set value, and the external device 810 may control the speaker to output the audio signal at the strength greater than or equal to the pre-set value based on feedback information. In the memory of the electronic device 800, output size information of audio signals corresponding respectively to the plurality of RSSI values may be stored, and the electronic device 800 may identify feedback information that outputs the audio signal by greater than or equal to a pre-set output strength based on the information stored in the memory and transmit to the external device 810.

Then, the electronic device 800 according to an embodiment may perform the secure connection with the external device 810 at operation S880. According to an example, the electronic device 800 may perform, based on the audio signal of the changed strength being received, the secure connection with the external device 810 based on the received audio signal. In this case, the connection via D2D communication may be ended.

According to the above-described example, if the speaker is included in the external device 810, the electronic device 800 may raise the success rate of the secure connection with the external device 810 by adjusting the strength of the audio signal being output from the external device 810.

FIG. 9 is a sequence diagram illustrating an operation of a communication system for when a microphone is included in an external device according to an embodiment of the disclosure.

Referring to FIG. 9, according to an embodiment, an external device 910 may first transmit a wireless communication signal to an electronic device 900 at operation S910. According to an example, the external device 910 may broadcast a Wireless-Fidelity (Wi-Fi) signal or Bluetooth low energy (BLE) advertising signal included with function information of the external device 910.

Then, the electronic device 900 according to an embodiment may identify that a microphone is included in the external device 910 based on the received wireless communication signal at operation S920. According to an example, the electronic device 900 may identify that the microphone is included in the external device 910 based on function information of the external device 910 included in the received wireless communication signal.

Then, the electronic device 900 according to an embodiment may identify an RSSI value of the received wireless communication signal at operation S930. According to an example, the electronic device 900 may identify, based on the wireless communication signal being received from the external device 910 through the communication interface 110, the RSSI value of the received wireless communication signal.

Then, the electronic device 900 according to an embodiment may transmit an audio signal for a secure connection based on the identified RSSI value at operation S940. According to an example, the electronic device 900 may further include memory (not shown) stored with output size information (or, output strength information) of audio signals corresponding respectively to a plurality of RSSI values. The electronic device 900 may identify, based on the identified RSSI value of the wireless communication signal being less than the pre-set value, the output size of the audio signal corresponding to the pre-set value based on the output size information of the audio signals corresponding respectively to the plurality of RSSI values stored in the memory (not shown), and control the speaker (not shown) to output an audio signal greater than or equal to the identified output size (or, output strength).

For example, the electronic device 900 may identify, based on the identified RSSI value of the wireless communication signal being less than 30 which is the pre-set value, the output size of the audio signal corresponding to 30 which is the pre-set value based on the output size information of the audio signals corresponding respectively to the plurality of RSSI values stored in the memory (not shown), and control the speaker (not shown) to output the audio signal by greater than or equal to the identified output size (or, output strength).

Then, the electronic device 900 according to an embodiment may perform the secure connection with the external device 910 at operation S950. According to an example, the electronic device 900 may control the speaker (not shown) to output an audio signal by greater than or equal to the identified output size, and the external device 910 may receive the audio signal from the electronic device 900 through the microphone. In the audio signal, at least one from among information on a personal identification number (PIN) code for ownership authentication of the external device 910 or information on the PIN code for ownership authentication of the electronic device 900 may be included, and the external device 910 may perform the secure connection with the electronic device 900 based on the received audio signal.

According to the above-described example, if the microphone is included in the external device 910, the electronic device 900 may raise the success rate of secure connection with the external device 910 by adjusting the strength of the audio signal being output from the speaker of the electronic device 900.

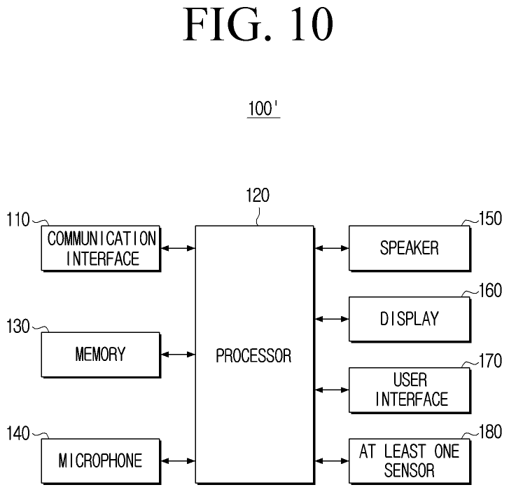

FIG. 10 is a block diagram illustrating a detailed configuration of an electronic device according to an embodiment of the disclosure.

Referring to FIG. 10, an electronic device 100′ may include the communication interface 110, one or more processors 120, memory 130, a microphone 140, a speaker 150, a display 160, a user interface 170, and at least one sensor 180. Detailed descriptions with respect to configurations that overlap with the configurations shown in FIG. 2 from among the configurations shown in FIG. 10 will be omitted.

The memory 130 may store data necessary for various embodiments. The memory 130 may be implemented in a form of memory embedded in the electronic device 100′ according to data storage use, or implemented in a form of memory attachable to or detachable from the electronic device 100′. For example, data for driving of the electronic device 100′ may be stored in the memory embedded in the electronic device 100′, and data for an expansion function of the electronic device 100′ may be stored in the memory attachable to or detachable from the electronic device 100′.

Meanwhile, the memory embedded in the electronic device 100′ may be implemented as at least one from among volatile memory (e.g., dynamic random access memory (DRAM), static RAM (SRAM), synchronous dynamic RAM (SDRAM), etc.), or non-volatile memory (e.g., one time programmable read only memory (OTPROM), programmable ROM (PROM), erasable and programmable ROM (EPROM), electrically erasable and programmable ROM (EEPROM), mask ROM, flash ROM, flash memory (e.g., NAND flash or NOR flash), a hard disk drive (HDD) or a solid state drive (SSD)). In addition, the memory attachable to or detachable from the electronic device 100′ may be implemented in a form such as, for example, and without limitation, a memory card (e.g., a compact flash (CF), a secure digital (SD), a micro secure digital (micro-SD), a mini secure digital (mini-SD), an extreme digital (xD), a multi-media card (MMC), etc.), external memory (e.g., USB memory) connectable to a USB port, or the like.

The microphone 140 may refer to a module that obtains sound and converts to an electric signal, and may be a condenser microphone, a ribbon microphone, a moving-coil microphone, a piezoelectric device microphone, a carbon microphone, or a micro electro mechanical system (MEMS) microphone. In addition, the above may be implemented in an omnidirectional method, a bidirectional method, a unidirectional method, a sub cardioid method, a super cardioid method, or a hyper cardioid method.

Various embodiments of the electronic device 100′ performing an operation corresponding to a user voice signal received through the microphone 140 may be provided.

In an example, the electronic device 100′ may control the display 160 based on the user voice signal received through the microphone 140. For example, if a user voice signal for displaying content A is received, the electronic device 100′ may control the display 160 to display content A.

In another example, the electronic device 100′ may control an external display device connected with the electronic device 100′ based on the user voice signal received through the microphone 140. Specifically, the electronic device 100′ may provide a control signal for controlling the external display device for an operation corresponding to the user voice signal to be performed in the external display device, and transmit the provided control signal to the external display device. Here, the electronic device 100′ may store a remote control application for controlling the external display device. Then, the electronic device 100′ may transmit the provided control signal to the external display device using at least one communication method from among Bluetooth, Wi-Fi, or infrared rays. For example, if the user voice signal for displaying content A is received, the electronic device 100′ may transmit a control signal for controlling content A to be displayed in the external display device to the external display device. Here, the electronic device 100′ may mean various terminal devices in which the remote control application can be installed such as, for example, and without limitation, a smartphone, an AI speaker, and the like.

In still another example, the electronic device 100′ may use a remote control device for controlling the external display device connected with the electronic device 100′ based on the user voice signal received through the microphone 140. Specifically, the electronic device 100′ may transmit the control signal for controlling the external display device for the operation corresponding to the user voice signal to be performed in the external display device to a remote control device. Then, the remote control device may transmit the control signal received from the electronic device 100′ to the external display device. For example, if the user voice signal for displaying content A is received, the electronic device 100′ may transmit the control signal for controlling for content A to be displayed in the external display device to the remote control device, and the remote control device may transmit the received control signal to the external display device.

The speaker 150 may be formed of a tweeter for playing back a high-range sound, a midrange for playing back a mid-range sound, a woofer for playing back a low-range sound, a sub-woofer for playing back an ultra-low range sound, an enclosure for controlling resonance, a cross-over network for dividing electric signal frequencies which are input to the speaker into bandwidths, and the like.

The speaker 150 may output sound signals to outside of the electronic device 100′. The speaker 150 may output playing back of multi-medias, playing back of recordings, various notification sounds, voice messages, and the like. The electronic device 100′ may include audio output devices such as the speaker 150, but may include an output device such as an audio output terminal. Specifically, the speaker 150 may provide obtained information, information processed and manufactured based on the obtained information, a response result or operation result for a user voice, and the like in a voice form.

The display 160 may be implemented as a display including self-emissive devices or a display including non-emissive devices and a backlight. For example, the above may be implemented as displays of various types such as, for example, and without limitation, a liquid crystal display (LCD), an organic light emitting diode (OLED) display, a light emitting diode (LED), a micro LED, a mini LED, a plasma display panel (PDP), a quantum dot (QD) display, a quantum dot light emitting diodes (QLED), or the like. In the display 160, a driving circuit, which may be implemented in a form of an a-si TFT, a low temperature poly silicon (LTPS) TFT, an organic TFT (OTFT), or the like, a backlight unit, and the like may be included. Meanwhile, the display 160 may be implemented as a touch screen coupled with a touch sensor, a flexible display, a rollable display, a three-dimensional display (3D display), a display physically coupled with a plurality of display modules, or the like. The processor 120 may control the display 160 to output an output image obtained according to the various embodiments described above. Here, the output image may be a high-resolution image of 4K or greater than or equal to 8K.

Meanwhile, according to another embodiment, the electronic device 100′ may not include the display 160. The electronic device 100′ may be connected with the external display device, and transmit an image or a content stored in the electronic device 100′ to the external display device. Specifically, the electronic device 100′ may transmit the image or content together with a control signal for controlling the image or the content to be displayed in the external display device to the external display device.

Here, the external display device may be connected with the electronic device 100′ through the communication interface 110 or an input and output interface (not shown). For example, the electronic device 100′ may not include a display like a set top box (STB). In addition, the electronic device 100′ may include only a small-scale display with which only simple information such as text information can be displayed. Here, the electronic device 100′ may transmit the image or content to the external display device by wired means or wireless means through the communication interface 110 or transmit to the external display device through the input and output interface (not shown).

The user interface 170 may be a configuration for the electronic device 100′ to perform an interaction with a user. For example, the user interface 170 may include at least one from among a touch sensor, a motion sensor, a button, a jog dial, a switch, a microphone, or a speaker, but is not limited thereto.

The at least one sensor 180 (hereinafter, referred to as a ‘sensor’) may include a plurality of sensors of various types. The sensor 180 may measure a physical quantity or detect an operating state of the electronic device 100′, and convert the measured or detected information to an electric signal. The sensor 180 may include a camera, and the camera may include a lens focusing visible rays and other optical signals received by being reflected by an object to an image sensor and the image sensor that can detect the visible rays and other optical signals. Here, the image sensor may include a 2D pixel array divided into a plurality of pixels.

According to the various embodiments described above, the electronic device 100′ may raise the success rate of communication connection with the external device by transmitting feedback information for the audio signal being output taking into consideration the strength of the signal received from the external device, or outputting the audio signal taking into consideration the strength of the received signal, and user satisfaction may be improved accordingly.

Meanwhile, methods according to the various embodiments of the disclosure described above may be implemented in an application form installable in an electronic device of the related art. Alternatively, methods according to the various embodiments of the disclosure described above may be performed using a deep learning-based trained neural network (or deep trained neural network), that is, a learning network model. In addition, the methods according to the various embodiments of the disclosure described above may be implemented with only a software upgrade, or a hardware upgrade for the electronic device of the related art. In addition, the various embodiments of the disclosure described above may be performed through an embedded server provided in the electronic device, or an external server of the electronic device.

Meanwhile, according to an embodiment of the disclosure, the various embodiments described above may be implemented with software including instructions stored in a machine-readable storage media (e.g., computer). The machine may call an instruction stored in the storage medium, and as a device operable according to the called instruction, may include a display device (e.g., display device (A)) according to the above-mentioned embodiments. Based on a command being executed by the processor, the processor may directly or using other elements under the control of the processor perform a function corresponding to the command. The command may include a code generated by a compiler or executed by an interpreter. A machine-readable storage medium may be provided in a form of a non-transitory storage medium. Herein, ‘non-transitory’ merely means that the storage medium is tangible and does not include a signal, and the term does not differentiate data being semi-permanently stored or being temporarily stored in the storage medium.

In addition, according to an embodiment, a method according to the various embodiments described above may be provided included a computer program product. The computer program product may be exchanged between a seller and a purchaser as a commodity. The computer program product may be distributed in a form of the machine-readable storage medium (e.g., a compact disc read only memory (CD-ROM)), or distributed online through an application store (e.g., PLAYSTORE™). In the case of online distribution, at least a portion of the computer program product may be stored at least temporarily in the machine-readable storage medium such as a server of a manufacturer, a server of an application store, or memory of a relay server, or temporarily generated.

In addition, each of the elements (e.g., a module or a program) according to the various embodiments described above may be configured as a single entity or a plurality of entities, and a portion of sub-elements of the above-mentioned sub-elements may be omitted, or other sub-elements may be further included in the various embodiments. Alternatively or additionally, a portion of the elements (e.g., modules or programs) may be integrated into one entity to perform the same or similar functions performed by the respective elements prior to integration. Operations performed by a module, a program, or another element, in accordance with the various embodiments, may be executed sequentially, in a parallel, repetitively, or in a heuristic manner, or at least a portion of the operations may be executed in a different order, omitted or a different operation may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
a communication interface;
memory storing one or more computer programs; and
one or more processors communicatively coupled to the communication interface and the memory,
wherein the one or more computer programs include computer-executable instructions that, when executed by the one or more processors individually or collectively, cause the electronic device to:
identify, based on a signal for a secure connection being received from an external device, a received signal strength indicator (RSSI) value of the received signal,
transmit, based on a speaker being identified as comprised in the external device based on function information of the external device comprised in the received signal, feedback information to the external device through the communication interface based on the identified RSSI value, and
perform, based on an updated signal being received from the external device based on the feedback information, the secure connection with the external device based on the updated signal.

2. The electronic device of claim 1, further comprising:
a microphone,
wherein the one or more computer programs further include computer-executable instructions that, when executed by the one or more processors individually or collectively, cause the electronic device to:
identify, based on an audio signal for the secure connection being received through the microphone and a wireless communication signal that comprises function information of the external device being received through the communication interface, a RSSI value of the received audio signal,
transmit, based on the speaker being identified as comprised in the external device based on function information of the external device, feedback information associated with a strength of the RSSI value to the external device through the communication interface based on the identified RSSI value, and
perform, based on an audio signal of a strength changed based on the feedback information being received from the external device, a secure connection with the external device based on the audio signal of the changed strength.

3. The electronic device of claim 1, wherein the one or more computer programs further include computer-executable instructions that, when executed by the one or more processors individually or collectively, cause the electronic device to:
perform, based on the speaker being identified as comprised in the external device based on function information of the external device comprised in a wireless communication signal received through the communication interface, a device-to-device (D2D) communication connection with the external device;
transmit, based on the identified RSSI value being identified as exceeding a pre-set range, feedback information associated with the pre-set range to the external device through the D2D communication connection; and
end, based on an audio signal of a strength changed based on the feedback information being received from the external device, the D2D communication connection and perform the secure connection.

4. The electronic device of claim 3, wherein the one or more computer programs further include computer-executable instructions that, when executed by the one or more processors individually or collectively, cause the electronic device to:
transmit, based on a RSSI value of the received signal being identified as steadily decreasing over time, feedback information for steadily increasing the RSSI value to the external device through the communication interface based on the pre-set range.

5. The electronic device of claim 3,
wherein the wireless communication signal comprises:
at least one from among a minimum value or a maximum value of an RSSI value for the secure connection, and
wherein the one or more computer programs further include computer-executable instructions that, when executed by the one or more processors individually or collectively, cause the electronic device to:
transmit, based on the RSSI value identified based on at least one from among the minimum value or the maximum value being identified as exceeding the pre-set range, feedback information associated with the pre-set range to the external device through the D2D communication connection, and
end, based on an audio signal of a strength changed based on the feedback information being received from the external device, the D2D communication connection and perform the secure connection.

6. The electronic device of claim 3, wherein the one or more computer programs further include computer-executable instructions that, when executed by the one or more processors individually or collectively, cause the electronic device to:
provide, based on the identified RSSI value being identified as exceeding the pre-set range, guide information that guides the electronic device to be positioned within a pre-set distance from the external device.

7. The electronic device of claim 2,
wherein the electronic device further comprises:
a speaker, and
wherein the one or more computer programs further include computer-executable instructions that, when executed by the one or more processors individually or collectively, cause the electronic device to:
identify an RSSI value of the wireless communication signal when a wireless communication signal is received from the external device through the communication interface, and
output, based on a microphone being identified as comprised in the external device based on function information of the external device comprised in the wireless communication signal, an audio signal for the secure connection with the external device through a speaker of the electronic device based on the identified RSSI value of the wireless communication signal.

8. The electronic device of claim 7, further comprising:
memory stored with output size information of audio signals corresponding to each of a plurality of RSSI values,
wherein the one or more computer programs further include computer-executable instructions that, when executed by the one or more processors individually or collectively, cause the electronic device to:
control, based on an RSSI value of the wireless communication signal being less than a pre-set value, the speaker of the electronic device to output the audio signal by greater than or equal to a pre-set output strength based on information stored in the memory.

9. The electronic device of claim 8, wherein the one or more computer programs further include computer-executable instructions that, when executed by the one or more processors individually or collectively, cause the electronic device to:
control, based on an RSSI value of the received signal being identified as steadily decreasing over time, the speaker of the electronic device for the output strength of the audio signal to be steadily increased based on information stored in the memory.

10. The electronic device of claim 2, wherein the one or more computer programs further include computer-executable instructions that, when executed by the one or more processors individually or collectively, cause the electronic device to:
identify, based on the speaker and a microphone being identified as comprised in the external device based on function information of the external device comprised in the received signal, a priority order of the speaker and the microphone;
transmit, based on the priority order of the speaker being identified as high, feedback information to the external device through the communication interface based on the identified RSSI value; and
output, based on the priority order of the microphone being identified as high, an audio signal for secure connection with the external device through the speaker of the electronic device based on the identified RSSI value of the wireless communication signal.

11. The electronic device of claim 2, wherein the wireless communication signal is at least one from among a Wireless-Fidelity (Wi-Fi) signal type or a Bluetooth Low Energy (BLE) advertising signal type.

12. A control method performed by an electronic device, the control method comprising:
identifying, based on a signal for a secure connection being received from an external device, a received signal strength indicator (RSSI) value of the received signal;
transmitting, based on a speaker being identified as comprised in the external device based on function information of the external device comprised in the received signal, feedback information to the external device based on the identified RSSI value; and
performing, based on an updated signal being received from the external device based on the feedback information, the secure connection with the external device based on the updated signal.

13. The control method of claim 12,
wherein the identifying an RSSI value comprises:
identifying, based on an audio signal for the secure connection being received through a microphone and a wireless communication signal comprising function information of the external device being received through a communication interface of the electronic device, an RSSI value of the received audio signal,
wherein the transmitting comprises:
transmitting, based on the speaker being identified as comprised in the external device based on function information of the external device, feedback information associated with a strength of the RSSI value to the external device through the communication interface based on the identified RSSI value, and wherein the performing the secure connection comprises:
performing, based on an audio signal of a strength changed based on the feedback information being received from the external device, the secure connection with the external device based on the audio signal of the changed strength.

14. The control method of claim 12, further comprising:
performing, based on the speaker being identified as comprised in the external device based on function information of the external device comprised in a wireless communication signal received through a communication interface, a device-to-device (D2D) communication connection with the external device,
wherein the transmitting comprises:
transmitting, based on the identified RSSI value being identified as exceeding a pre-set range, feedback information associated with the pre-set range to the external device through the D2D communication connection, and wherein the performing the secure connection comprises:
ending, based on an audio signal of a strength changed based on the feedback information being received from the external device, the D2D communication connection and performing the secure connection.

15. The control method of claim 14, wherein the transmitting comprises:
transmitting, based on an RSSI value of the received signal being identified as steadily decreasing over time, feedback information for steadily increasing the RSSI value to the external device based on the pre-set range.

16. The control method of claim 14,
wherein the wireless communication signal comprises:
at least one from among a minimum value or a maximum value of an RSSI value for the secure connection, and
wherein the method further comprises:
transmitting, based on the RSSI value identified based on at least one from among the minimum value or the maximum value being identified as exceeding the pre-set range, feedback information associated with the pre-set range to the external device through the D2D communication connection, and
ending, based on an audio signal of a strength changed based on the feedback information being received from the external device, the D2D communication connection and perform the secure connection.

17. The control method of claim 14, further comprising:
providing, based on the identified RSSI value being identified as exceeding the pre-set range, guide information that guides the electronic device to be positioned within a pre-set distance from the external device.

18. The control method of claim 13, further comprising:
identifying an RSSI value of the wireless communication signal when a wireless communication signal is received from the external device through the communication interface, and
outputting, based on a microphone being identified as comprised in the external device based on function information of the external device comprised in the wireless communication signal, an audio signal for the secure connection with the external device through a speaker of the electronic device based on the identified RSSI value of the wireless communication signal.

19. One or more non-transitory computer-readable storage media storing one or more computer programs including computer-executable instructions that, when executed by one or more processors of an electronic device individually or collectively, cause the electronic device to perform operations, the operations comprising:
identifying, based on a signal for a secure connection being received from an external device, a received signal strength indicator (RSSI) value of the received signal;
transmitting, based on a speaker being identified as comprised in the external device based on function information of the external device comprised in the received signal, feedback information to the external device based on the identified RSSI value; and
performing, based on an updated signal being received from the external device based on the feedback information, the secure connection with the external device based on the updated signal.

20. The one or more non-transitory computer-readable storage media of claim 19, wherein the identifying an RSSI value comprises:
identifying, based on an audio signal for the secure connection being received through a microphone and a wireless communication signal comprising function information of the external device being received through a communication interface of the electronic device, an RSSI value of the received audio signal,
wherein the transmitting comprises:
transmitting, based on the speaker being identified as comprised in the external device based on function information of the external device, feedback information associated with a strength of the RSSI value to the external device through the communication interface based on the identified RSSI value, and wherein the performing the secure connection comprises:
performing, based on an audio signal of a strength changed based on the feedback information being received from the external device, the secure connection with the external device based on the audio signal of the changed strength.
